(19) United States
(12) Patent Application Publication
(10) Pub. No.: US 2026/0009722 A1
(43) Pub. Date: Jan. 8, 2026

(54) AUTOMATED UNDERWATER SENSOR CLEANING DEVICE AND METHOD

(71) Applicant: ELECTRONICS AND TELECOMMUNICATIONS RESEARCH INSTITUTE, Daejeon (KR)

(72) Inventor: Jae Young KIM, Daejeon (KR)

(73) Assignee: ELECTRONICS AND TELECOMMUNICATIONS RESEARCH INSTITUTE, Daejeon (KR)

(21) Appl. No.: 19/224,341

(22) Filed: May 30, 2025

(30) Foreign Application Priority Data
Jul. 4, 2024 (KR) 10-2024-0088399

(51) Int. Cl. G01N 21/15; A01K 63/10; A46B 13/00; A46B 13/02; A46B 15/00; G01N 21/59

(52) U.S. Cl. CPC G01N 21/15; A01K 63/10; A46B 13/001; A46B 13/02; A46B 15/0004; G01N 21/59; A46B 2200/3013; G01N 2021/152

(57) ABSTRACT

An automated underwater sensor cleaning device according to one embodiment of the present invention includes a sensor protection tube, a movable cleaner that is installed on the sensor protection tube and cleans the sensor protection tube while vertically moving along the sensor protection tube, and a controller configured to control an operation of the movable cleaner.

### CROSS-REFERENCE TO RELATED APPLICATION

The present application claims priority and the benefit of Korean Patent Application No. 10-2024-0088399, filed on Jul. 4, 2024 in the Korean Intellectual Property Office, the entire disclosure of which is incorporated herein by reference.

### BACKGROUND

### 1. Field of the Invention

Embodiments of the present invention relate to an automated underwater sensor cleaning device and method.

### 2. Discussion of Related Art

An accurate measurement of sensors used in an underwater environment may interfere with food or attachments accumulated on surfaces of the sensors over time. Current sensors used in an underwater environment require periodic manual cleaning, which increases operating costs and requires human resources for maintenance. The sensors used in the underwater environment are referred to as underwater sensors.

Conventional methods of solving problems caused by the deposition of dirt on underwater sensors are as follows. That is, a mechanism that detects and automatically cleans food adhered to a sensor can be implemented as one method. To this end, the mechanism can be implemented to include a detector that detects food which has been adhered to the sensor, and a cleaning device is operated to make the sensor clean when the food is found.

In this case, special coating can be applied to the sensor to prevent a biofilm from forming on a surface of the sensor, and such coating allows less fish food to adhere to the surface of the sensor, thereby increasing the accuracy and reliability of the sensor. Additionally, the sensor can move periodically to prevent the food from adhering directly to the sensor, which will ensure that the food around the sensor is evenly distributed, allowing the sensor to operate accurately while maintaining a fish farming environment.

The background technology of the present invention is disclosed in Korean Laid-Open Patent No. 10-2019-0138432 (published on Dec. 13, 2019).

### SUMMARY OF THE INVENTION

The present invention is directed to providing an automated underwater sensor cleaning device and method that allow a sensor to be automatically cleaned in an underwater environment to increase the accuracy and lifetime of the sensor and reduce operating costs.

An automated underwater sensor cleaning device according to one embodiment of the present invention includes a sensor protection tube, a movable cleaner that is installed on the sensor protection tube and cleans the sensor protection tube while vertically moving along the sensor protection tube, and a controller configured to control an operation of the movable cleaner.

The sensor protection tube may be formed to have a tubular shape with an open upper portion, and an underwater sensor may be installed on an inner lower surface of the sensor protection tube.

The sensor protection tube may have a plurality of holes formed to prevent contaminants other than water from passing therethrough.

The movable cleaner may include a movable cleaning tube installed outside the sensor protection tube, and a cleaning brush that is installed inside the movable cleaning tube and cleans an exterior of the sensor protection tube according to an operation of the movable cleaning tube.

The movable cleaning tube may be formed to have a tubular shape that surrounds the exterior of the sensor protection tube.

The cleaning brush may be installed to surround an interior of the movable cleaning tube.

The controller may include a motor configured to vertically move the movable cleaning tube, and a processor configured to control driving of the motor.

The processor may transmit a control signal for driving the motor to the motor based on operation setting information received through an input unit or operation setting information stored in a memory to vertically move the movable cleaning tube so as to automatically clean the sensor protection tube.

The underwater sensor may include a non-contact sensor configured to measure a transparency of the sensor protection tube, and when the transparency measured by the non-contact sensor exceeds a preset threshold value, the processor may output a control signal for driving the motor to vertically move the movable cleaning tube through the motor so as to automatically clean the sensor protection tube.

An automated underwater sensor cleaning method according to one embodiment of the present invention includes outputting, by a controller, a control signal for controlling an operation of a movable cleaner installed on a sensor protection tube, and cleaning, by the movable cleaner, the sensor protection tube while vertically moving along the sensor protection tube based on the control signal.

The sensor protection tube may be formed to have a tubular shape with an open upper portion, and an underwater sensor may be installed on an inner lower surface of the sensor protection tube.

The sensor protection tube may have a plurality of holes formed to prevent contaminants other than water from passing therethrough.

The movable cleaner may include a movable cleaning tube installed outside the sensor protection tube, and a cleaning brush that is installed inside the movable cleaning tube and cleans an exterior of the sensor protection tube according to an operation of the movable cleaning tube.

The movable cleaning tube may be formed to have a tubular shape that surrounds the exterior of the sensor protection tube.

The cleaning brush may be installed to surround an interior of the movable cleaning tube.

The controller may include a motor configured to vertically move the movable cleaning tube, and a processor configured to control driving of the motor.

The processor may transmit a control signal for driving the motor to the motor based on operation setting information received through an input unit or operation setting information stored in a memory to vertically move the movable cleaning tube so as to automatically clean the sensor protection tube.

The underwater sensor may include a non-contact sensor configured to measure a transparency of the sensor protection tube, and when the transparency measured by the non-contact sensor exceeds a preset threshold value, the processor may output a control signal for driving the motor to vertically move the movable cleaning tube through the motor so as to automatically clean the sensor protection tube.

### BRIEF DESCRIPTION OF THE DRAWINGS

The following drawings attached to the present specification illustrate embodiments of the present invention and further describe aspects and features of the present invention together with the detailed description of the present invention.

Thus, the present invention should not be construed as being limited to the drawings, in which:

FIG. 1 is a configuration diagram of an automated underwater sensor cleaning device according to one embodiment of the present invention;

FIG. 2 is a block diagram showing a specific configuration of a controller of FIG. 1;

FIGS. 3 and 4 are usage state diagrams of the automated underwater sensor cleaning device according to one embodiment of the present invention; and

FIG. 5 is a flowchart for describing an automated underwater sensor cleaning method according to one embodiment of the present invention.

### DETAILED DESCRIPTION OF EXEMPLARY EMBODIMENTS

Hereinafter, embodiments of the present invention will be described. In this description, thicknesses of lines, sizes of components, etc., shown in the drawings may be exaggerated for clarity and convenience of the description. In addition, terms to be described below are the terms defined in consideration of functions in the present invention, which may be changed according to a user or operator's intention or custom. Accordingly, the definition of these terms should be made based on the description throughout the present specification.

Hereinafter, embodiments of the present invention will be described in detail with reference to the accompanying drawings so that those skilled in the art to which the present invention pertains can easily carry out the present invention. However, the present invention may be implemented in various different forms and is not limited to the embodiments described herein. In addition, to clearly describe the present invention in the drawings, parts irrelevant to the description have been omitted, and throughout the specification, similar parts have been denoted as similar reference numerals.

Throughout the specification, when a certain portion is described as “including” a certain element, it means that the certain portion may further include another element rather than precluding another element unless specifically stated to the contrary.

The implementation described in the present specification may be implemented, for example, as a method or process, device, a software program, a data stream, or a signal. Although described only in the context of the implementation of a single form (e.g., only a method is described), the implementations of the described features may also be implemented in other forms (e.g., devices or programs). The device may be implemented with appropriate hardware, software, firmware, etc. The method may be implemented by a device such as a processor, which is generally referred to as a processing device including, for example, a computer, a microprocessor, an integrated circuit, a programmable logic device, etc.

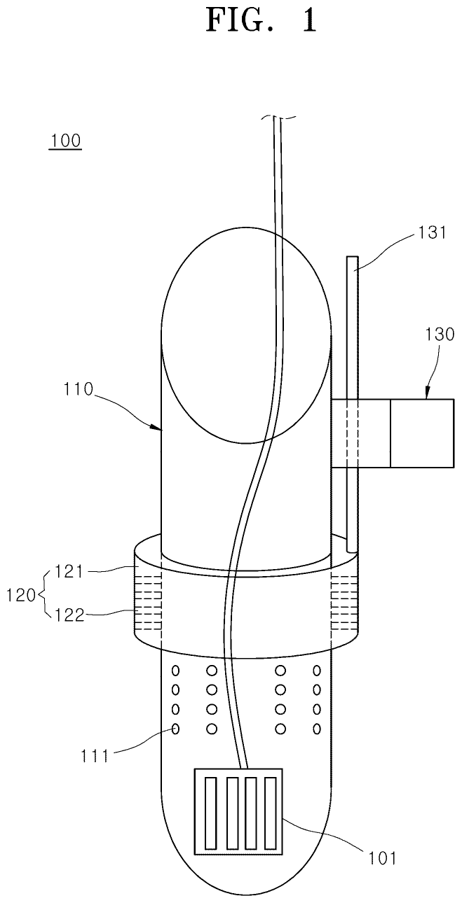

FIG. 1 is a configuration diagram of an automated underwater sensor cleaning device according to one embodiment of the present invention.

Referring to FIG. 1, an automated underwater sensor cleaning device 100 according to one embodiment of the present invention may include a sensor protection tube 110, a movable cleaner 120, and a controller 130.

The sensor protection tube 110 serves to protect an underwater sensor 101. That is, the sensor protection tube 110 may be configured to prevent damage and deposition of the underwater sensor 101 due to food, waste, and small fish.

To this end, the sensor protection tube 110 may be formed to have a tubular shape in which the underwater sensor 101 is installed on an inner lower surface thereof. That is, the sensor protection tube 110 may be formed to have a tubular shape that is formed to extend vertically and have a larger width than the underwater sensor 101, and in this case, formed to have an open upper portion.

However, the sensor protection tube 110 is not limited thereto and may be formed in various shapes. For example, the sensor protection tube 110 may be formed in a triangular, square column, etc., that extends vertically.

The sensor protection tube 110 may have a plurality of holes 111 formed so that contaminants other than water do not pass therethrough. Here, the holes 111 may serve to ensure that there is no problem with a sensing function of the underwater sensor 101.

The holes 111 may be installed at a predetermined interval on a lower side surface of the sensor protection tube 110. In addition, the holes 111 may have a structure in which multiple holes are arranged side by side along a straight line. In this case, a size of the hole 111 may be designed appropriately as needed, and, for example, the hole may be designed so that there is no problem with the sensing function of the underwater sensor 101 and contaminants can be prevented from passing therethrough.

The movable cleaner 120 may be installed on the sensor protection tube 110 and may clean the sensor protection tube 110 while vertically moving along the sensor protection tube 110. To this end, the movable cleaner 120 may include a movable cleaning tube 121 and a cleaning brush 122.

The movable cleaning tube 121 may be installed outside the sensor protection tube 110. Specifically, the movable cleaning tube 121 may be formed to have a tubular shape surrounding an exterior of the sensor protection tube 110.

The movable cleaning tube 121 may be operated by motor control of the controller 130 to move in a longitudinal direction of the sensor protection tube 110, that is, in a vertical direction. Alternatively, the movable cleaning tube 121 may receive a control signal from the controller 130 and operate according to the received control signal to vertically move along the sensor protection tube 110.

Here, the control signal may be received periodically, or alternatively, various implementations are possible to receive the control signal as needed based on input data or sensing data.

The cleaning brush 122 may be installed inside the movable cleaning tube 121. Specifically, the cleaning brush 122 may be installed to surround (a portion or the entirety of) an interior of the movable cleaning tube 121.

The cleaning brush 122 may clean the exterior of the sensor protection tube 110 according to the operation of the movable cleaning tube 121. That is, when the movable cleaning tube 121 is vertically moved along the sensor protection tube 110 by the controller 130, the cleaning brush 122 moves in conjunction with the operation of the movable cleaning tube 121, thereby removing food or contaminants adhered to the exterior of the sensor protection tube 110.

The controller 130 may be mechanically connected to the movable cleaner 120 to perform a function of controlling the operation of the movable cleaner 120. However, the controller 130 is not limited thereto and may be electrically connected to the movable cleaner 120 to control the operation of the movable cleaner 120.

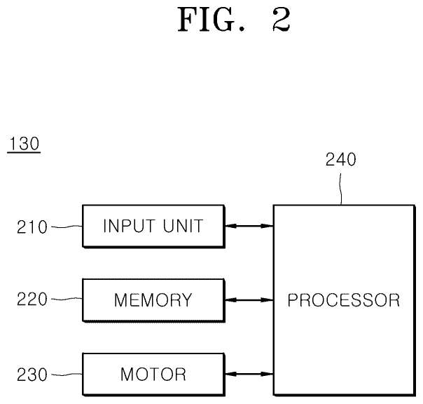

To this end, the controller 130 may include a motor 230 for vertically moving the movable cleaning tube 121 and a processor 240 for controlling the operation of the motor 230 as shown in FIG. 2. For reference, FIG. 2 is a block diagram showing a specific configuration of the controller 130 of FIG. 1.

Here, the motor 230 may be implemented as an actuator. The actuator may convert the rotational motion of the motor 230 into the linear motion to move a rod 131 forward or rearward.

The movable cleaner 120 may be connected to one end of a rod 131, and the movable cleaner 120 may vertically move along the sensor protection tube 110 according to the forward or rearward movement of the rod 131. Through such an operation, the movable cleaner 120 may clean the exterior of the sensor protection tube 110.

Specifically, the movable cleaning tube 121 may be fixedly connected to a lower end of the rod 131. When the rod 131 moves forward or rearward according to the driving of the motor 230, the movable cleaning tube 121 may vertically move along the sensor protection tube 110 in conjunction with the above movement.

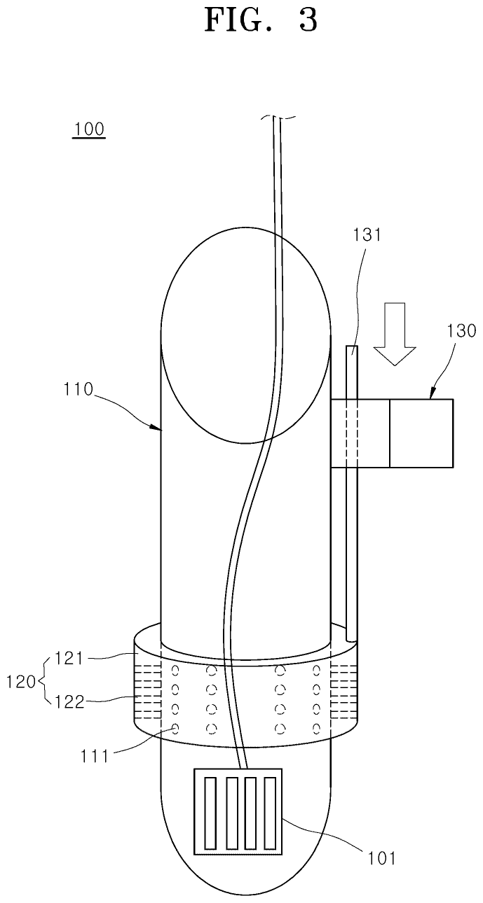

For example, when the rod 131 moves forward according to the driving of the motor 230, as shown in FIG. 3, the movable cleaning tube 121 may move downward along the sensor protection tube 110.

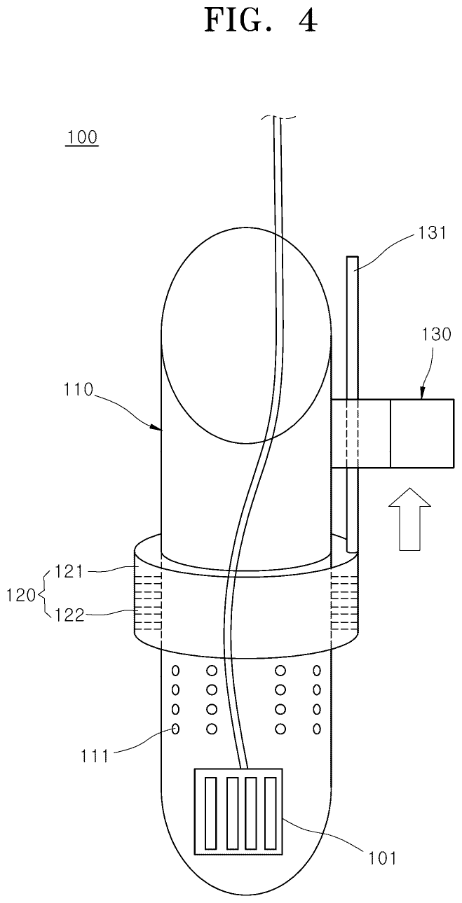

On the other hand, when the rod 131 moves rearward according to the driving of the motor 230, as shown in FIG. 4, the movable cleaning tube 121 may move upward along the sensor protection tube 110.

In this way, the movable cleaning tube 121 may vertically move along the sensor protection tube 110, and thus the cleaning brush 122 can remove contaminants and the like that are stuck or adhered to the exterior of the sensor protection tube 110 through friction with the sensor protection tube 110.

Accordingly, according to one embodiment of the present invention, by automatically cleaning the exterior of the sensor protection tube 110 protecting the underwater sensor 101, it is possible to minimize the influence of the external environment of the underwater sensor 101, thereby improving the performance and lifetime of the underwater sensor 101 and further reducing the operating cost of the underwater sensor 101.

The controller 130 may further include an input unit 210 and a memory 220 as shown in FIG. 2.

The processor 240 may transmit a control signal for driving the motor 230 to the motor 230 based on operation setting information received through the input unit 210. Accordingly, the processor 240 may automatically clean the sensor protection tube 110 by vertically moving the movable cleaning tube 121.

Alternatively, the processor 240 may transmit the control signal for driving the motor 230 to the motor 230 based on the operation setting information stored in the memory 220, thereby automatically cleaning the sensor protection tube 110 by vertically moving the movable cleaning tube 121.

Here, the operation setting information may include information such as a driving time, a driving cycle, a driving intensity, etc., of the motor 230. The control signal may be generated based on the operation setting information to drive the motor 230.

Meanwhile, the underwater sensor 101 may include a non-contact sensor for measuring the transparency of the sensor protection tube 110. The non-contact sensor may transmit the measured transparency of the sensor protection tube 110 to the processor 240.

The processor 240 may compare the measured transparency measured through the non-contact sensor with a preset threshold value. As the result of the comparison, when the measured transparency exceeds the threshold value, the processor 240 may output the control signal for driving the motor 230.

The motor 230 may operate the movable cleaning tube 121 according to the control signal. Accordingly, the processor 240 may vertically move the movable cleaning tube 121 through the motor 230 to automatically clean the sensor protection tube 110.

In this case, the non-contact sensor may operate periodically. That is, the non-contact sensor may output a measurement value by periodically measuring the transparency of the sensor protection tube 110. Meanwhile, when the transparency measured through the non-contact sensor is the preset threshold value or less, the processor 240 may output a stop signal or no signal depending on whether the motor 230 is driven.

That is, when the motor 230 is being driven, the processor 240 may output the stop signal to stop the driving of the motor 230. On the other hand, when the motor 230 is not driven, the processor 240 does not output any signal, and thus the stopped state of the motor 230 can be maintained.

The above devices may be implemented by hardware components, software components, and/or a combination of hardware components and software components.

For example, the devices and components described in the embodiments may be implemented by using one or more general-purpose or special-purpose computers such as a processor, a controller, an arithmetic logic unit (ALU), a digital signal processor, a microcomputer, a field programmable array (FPA), a programmable logic unit (PLU), a microprocessor, or other devices capable of executing and responding to instructions.

The processing device may run an operating system (OS) and one or more software applications running on the operating system. In addition, the processing device may access, store, manipulate, process, and generate data in response to the execution of software. For better understanding, the processing device may be described as a single device, but those skilled in the art can know that the processing device may include multiple processing elements and/or multiple types of processing elements. For example, the processing device may include a plurality of processors or one processor and one controller. In addition, other processing configurations, such as parallel processors, are possible.

Software may include computer programs, code, instructions, or a combination thereof, which may independently or collectively configure or instruct the processing device to operate as desired. The software and/or data may be stored in a storage medium such as a memory to be interpreted by the processing device or to provide instructions or data to the processing device.

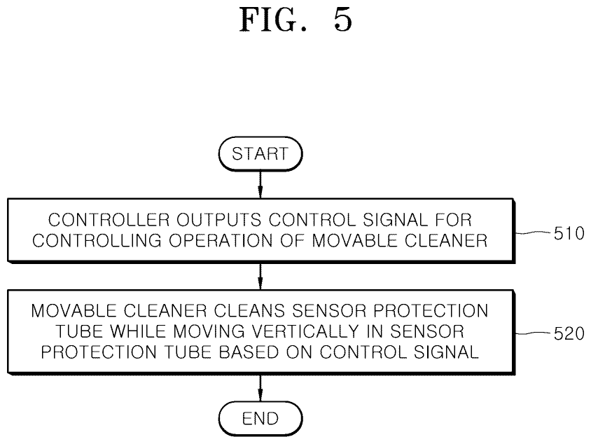

FIG. 5 is a flowchart for describing an automated underwater sensor cleaning method according to one embodiment of the present invention.

The automated underwater sensor cleaning method to be described herein is only one embodiment of the present invention, various operations may be added as follows as needed, and the following operations may also be implemented by changing the order, and thus the present invention is not limited to each operation and the order that will be described below.

Referring to FIGS. 1, 2, and 5, in operation 510, the controller 130 may output a control signal for controlling the operation of the movable cleaner 120 installed on the sensor protection tube 110.

In this case,, the controller 130 may output a control signal periodically, or alternatively, various implementations are possible to output the control signal as needed based on input data or sensing data.

Next, in operation 520, the movable cleaner 120 may clean the outer surface of the sensor protection tube 110 while vertically moving along the sensor protection tube 110 based on the control signal.

Specifically, the movable cleaning tube 121 is vertically moved along the sensor protection tube 110 by the controller 130. Then, the cleaning brush 122 moves in conjunction with the operation of the movable cleaning tube 121, and thus food or contaminants adhered to the exterior of the sensor protection tube 110 can be removed.

In this way, in one embodiment of the present invention, by automatically cleaning the exterior of the sensor protection tube 110 protecting the underwater sensor 101, it is possible to minimize the influence of the external environment of the underwater sensor 101, thereby improving the performance and lifetime of the underwater sensor 101 and further reducing the operating cost of the underwater sensor 101.

According to the present invention, since a sensor is automatically cleaned in an underwater environment, it is possible to increase the accuracy and lifetime of the sensor and reduce operating costs.

According to the present invention, it is possible to maintain the performance of an underwater sensor and minimize the influence of an external environment.

Although the present invention has been described with reference to embodiments shown in the drawings, these are merely exemplary, and those skilled in the art will understand that various modifications and equivalent other embodiments are possible therefrom. Accordingly, the technical scope of the present invention should be determined by the appended claims.

What is claimed is:

1. An automated underwater sensor cleaning device comprising:
a sensor protection tube;
a movable cleaner that is installed on the sensor protection tube and cleans the sensor protection tube while vertically moving along the sensor protection tube; and
a controller configured to control an operation of the movable cleaner.

2. The automated underwater sensor cleaning device of claim 1, wherein the sensor protection tube is formed to have a tubular shape with an open upper portion, and an underwater sensor is installed on an inner lower surface of the sensor protection tube.

3. The automated underwater sensor cleaning device of claim 1, wherein the sensor protection tube has a plurality of holes formed to prevent contaminants other than water from passing therethrough.

4. The automated underwater sensor cleaning device of claim 1, wherein the movable cleaner includes:
a movable cleaning tube installed outside the sensor protection tube; and
a cleaning brush that is installed inside the movable cleaning tube and cleans an exterior of the sensor protection tube according to an operation of the movable cleaning tube.

5. The automated underwater sensor cleaning device of claim 4, wherein the movable cleaning tube is formed to have a tubular shape that surrounds the exterior of the sensor protection tube.

6. The automated underwater sensor cleaning device of claim 4, wherein the cleaning brush is installed to surround an interior of the movable cleaning tube.

7. The automated underwater sensor cleaning device of claim 1, wherein the controller includes:
a motor configured to vertically move the movable cleaning tube; and
a processor configured to control driving of the motor.

8. The automated underwater sensor cleaning device of claim 7, wherein the processor transmits a control signal for driving the motor to the motor based on operation setting information received through an input unit or operation setting information stored in a memory to vertically move the movable cleaning tube so as to automatically clean the sensor protection tube.

9. The automated underwater sensor cleaning device of claim 7, wherein the underwater sensor includes a non-contact sensor configured to measure a transparency of the sensor protection tube, and
when the transparency measured by the non-contact sensor exceeds a preset threshold value, the processor outputs a control signal for driving the motor to vertically move the movable cleaning tube through the motor so as to automatically clean the sensor protection tube.

10. An automated underwater sensor cleaning method comprising:
outputting, by a controller, a control signal for controlling an operation of a movable cleaner installed on a sensor protection tube; and
cleaning, by the movable cleaner, the sensor protection tube while vertically moving along the sensor protection tube based on the control signal.

11. The automated underwater sensor cleaning method of claim 10, wherein the sensor protection tube is formed to have a tubular shape with an open upper portion, and an underwater sensor is installed on an inner lower surface of the sensor protection tube.

12. The automated underwater sensor cleaning method of claim 10, wherein the sensor protection tube has a plurality of holes formed to prevent contaminants other than water from passing therethrough.

13. The automated underwater sensor cleaning method of claim 10, wherein the movable cleaner includes:
a movable cleaning tube installed outside the sensor protection tube; and
a cleaning brush that is installed inside the movable cleaning tube and cleans an exterior of the sensor protection tube according to an operation of the movable cleaning tube.

14. The automated underwater sensor cleaning method of claim 13, wherein the movable cleaning tube is formed to have a tubular shape that surrounds the exterior of the sensor protection tube.

15. The automated underwater sensor cleaning method of claim 13, wherein the cleaning brush is installed to surround an interior of the movable cleaning tube.

16. The automated underwater sensor cleaning method of claim 10, wherein the controller includes:
a motor configured to vertically move the movable cleaning tube; and
a processor configured to control driving of the motor.

17. The automated underwater sensor cleaning method of claim 16, wherein the processor transmits a control signal for driving the motor to the motor based on operation setting information received through an input unit or operation setting information stored in a memory to vertically move the movable cleaning tube so as to automatically clean the sensor protection tube.

18. The automated underwater sensor cleaning method of claim 16, wherein the underwater sensor includes a non-contact sensor configured to measure a transparency of the sensor protection tube, and
when the transparency measured by the non-contact sensor exceeds a preset threshold value, the processor outputs a control signal for driving the motor to vertically move the movable cleaning tube through the motor so as to automatically clean the sensor protection tube.
